(19) United States
(12) Patent Application Publication
(10) Pub. No.: US 2008/0129985 A1
(43) Pub. Date: Jun. 5, 2008

(54) Slanted Bragg Grating Refractometer, Using the Optical Power Diffracted to the Radiation-Mode Continuum

(75) Inventors: Guillaume Laffont, Bois D'Arcy (FR); Cecile Prudhomme, Paris (FR); Pierre Ferdinand, Houills (FR)

Correspondence Address: THELEN REID BROWN RAYSMAN & STEINER LLP, P. O. BOX 640640, SAN JOSE, CA, 95164-0640, US

(73) Assignee: COMMISSARIAT A L'ENERGIE ATOMIQUE, Paris (FR)

(21) Appl. No.: 11/792,757

(22) PCT Filed: Dec. 7, 2005
(86) PCT No.: PCT/FR05/51049

§ 371 Date: Jun. 8, 2007

(30) Foreign Application Priority Data
Dec. 10, 2004 (FR) 04 52922

(51) Int. Cl. G01N 21/41

(52) U.S. Cl. 356/128

(57) ABSTRACT

This refractometer includes at least one optical waveguide (2) comprising at least one slanted Bragg grating (4), formed in a part of the waveguide, which is placed in contact with the medium (7) of which the refraction index is to be determined, a light source (10) coupled to the waveguide in order to send this light there and have it interact with the grating, means (17) for measuring the optical power of the light diffracted to the radiation-mode continuum, when the light transmitted by the source interacts with the grating, and electronic processing means (22) for supplying the value of the refraction index of the medium based on this optical power.

### TECHNICAL FIELD

This invention relates to a refractometer, i.e. a system for measuring refraction indices.

It applies in particular to the measurement of the refraction index of a liquid or a gas or any other product or chemical compound in contact with an optical waveguide, in particular deposited on this optical waveguide.

The latter can be, for example, an optical fibre or an integrated optical waveguide.

The refractometer includes one or more transducers formed on the optical waveguide, each transducer being a slanted Bragg grating, also called a tilted Bragg grating or a blazed Bragg grating.

If Bragg gratings continually grow in the field of physical-type measurements (for example measurements of deformations, temperature and pressure), much work remains to be done in order to broaden their field of application to physicochemical-type measurements. The development of transducers of physicochemical parameters (for example for measuring concentrations and detecting chemical species) using Bragg gratings involves the production of transducers sensitive to the refraction index of the surrounding medium, whether solid, liquid or gaseous.

Much work has been performed in order to produce optical fibre sensors making it possible to measure the refraction index of a medium, but very little of this work deals with the use of Bragg gratings. It concerns primarily evanescent wave sensors or surface plasmon sensors.

However, a refractometer that uses a slanted Bragg grating is known, and will be described below.

### PRIOR ART

Optical fibre sensors used for refractometry include not only evanescent wave sensors and surface plasmon sensors, but also sensors using standard Bragg gratings or short period Bragg gratings, and sensors using long period Bragg gratings.

All of these sensors have disadvantages, which are mentioned in the following document, to which reference will be made:

[1] Refractometer with blazed Bragg grating, WO 02/44697 A, invention of Guillaume Laffont and Pierre Ferdinand, corresponding to FR 2 814 810 A and to the American patent application of which the Ser. No. 09/926,511, and which was filed on 13 Nov. 2001.

A slanted short period Bragg grating differs from a standard short period Bragg grating in that the refraction index modulation, which is photoinscribed in the core of the optical waveguide, in general an optical fibre, containing this grating, is tilted with respect to the axis of propagation of this optical fibre. By contrast, the period of a standard short period Bragg grating and the period of a slanted short period Bragg grating are on the same order of magnitude: they are generally around 0.5 μm.

One of the major benefits of a slanted short period Bragg grating lies in its high spectral sensitivity to the refraction index of the external medium of the optical fibre. This sensitivity has already been used to advantage to develop the refractometer known from document [1].

A slanted short period Bragg grating, more simply called a “slanted Bragg grating”, consists of a sinusoidal modulation of the refraction index of the core of a single-mode optical waveguide, in general a single-mode optical fibre, but with the following specific feature: the lattice vector \vec{K} associated with the index modulation is tilted with respect to the axis of propagation of the optical fibre.

This geometry breaks the rotational symmetry of the component and creates coupling phenomena between more complex modes than in the case of a grating with rotational symmetry (such as a standard short period Bragg grating). Briefly, by suppressing this symmetry, a coupling is made possible not only between modes of the same azimuthal symmetry, but also between modes of all types of symmetry.

In the case of a short period Bragg grating, the spectral response in transmission is characterised by the existence of a spectral resonance, called a Bragg resonance, which corresponds to a coupling induced by the grating between the incident fundamental guided mode and the contrapropagative fundamental guided mode. On the side of the shorter wavelengths, a set of spectral resonances with lower amplitudes is observed. These resonances correspond to a coupling induced by the Bragg grating between the incident fundamental guided mode and modes called “contrapropagative cladding modes”, which are guided no longer by the core of the optical fibre but by the optical cladding of this fibre. In reflection, only the Bragg resonance can be observed while the reflected light, corresponding to the resonances associated with cladding modes, is absorbed very quickly (typically in several centimetres) in the optical fibre.

The spectral response of a slanted Bragg grating is characterised by more significant phenomena of coupling of the fundamental guided mode to cladding modes of the optical fibre, but also by phenomena of coupling of the fundamental guided mode to the continuum of radiation-modes that correspond to light escaping the optical fibre. These couplings to radiation-modes involve, on the spectral response, no longer discrete resonances (as for cladding modes), but a continuous loss band.

When a slanted Bragg grating is placed in the air, with a refraction index almost equal to 1, its spectral response in transmission is characterised almost exclusively by couplings between the incident fundamental guided mode and contrapropagative cladding modes: consequently, a set of discrete spectral resonances is observed.

A definite number of cladding modes are significantly involved in these couplings: for a given fibre, this number is determined by the angle of tilt of the lines of the slanted Bragg grating. The number of modes involved increases with the tilt of the lines. In addition, the more tilted the lines of the grating are, the more cladding modes of higher order (and therefore with a low resonance wavelength and effective index), and even radiation-modes, are involved. On the spectral response in transmission, this involves the presence of an increasing number of spectral resonances. For a given slanted Bragg grating, the lower the spectral resonance wavelength is and the more the cladding mode associated with this resonance has a lower effective index and a higher order.

When the refraction index nₑₓₜ of the external medium becomes different from 1, the spectral response changes. The more the value of this refraction index increases, and the more the spectral resonances are offset toward the long wavelengths. Simultaneously, their amplitude will tend to decrease. For a given spectral resonance, this decrease in amplitude means that the efficiency of the coupling between the incident fundamental guided mode and the cladding mode decreases. At this wavelength, the part of the light energy that is no longer diffracted to the cladding mode is coupled to the radiation-mode continuum. This radiation-mode continuum corresponds to light that escapes the optical fibre.

When nₑₓₜ reaches a threshold value, the spectral resonance disappears completely: the energy diffracted by the grating at this wavelength is entirely coupled to radiation-modes. For a given, cladding mode, this threshold value is reached when there is a match between the refraction index of the external medium and the effective index of the cladding mode. In this case, for this cladding mode, everything happens as if the optical cladding had totally disappeared: it can no longer be guided and the energy escapes the optical fibre in radiation form.

That being the case, the amplitude reduction and the spectral shift do not occur in parallel on the all of the spectral resonances. The resonances with shorter wavelengths, which are therefore associated with the lowest effective cladding indices, are first affected by the increase in the refraction index of the external medium. This special feature is used to advantage in document [1] to determine the external refraction index that is responsible for this spectrally selective change.

Thus, as this index increases, the spectral resonances disappear until a perfectly smooth loss spectrum is obtained: then there is a match between the refraction index of the external medium and that of the optical cladding. The light diffracted by the slanted Bragg grating on the entire spectral window is then entirely coupled to the radiation-mode continuum.

For values of nₑₓₜ greater than the refraction index of the optical cladding, there is no longer matching with the refraction index of the optical cladding. An interface between the optical cladding and the external medium exists again. This interface results in a re-trapping of a part of the light diffracted to the radiation-modes in the form of cladding modes. However, these are no longer cladding modes obtained by total reflection at the optical cladding-external medium interface (the refraction index of the external medium being greater than that of the optical cladding), but by Fresnel reflection. Consequently, a set of spectral resonances progressively and simultaneously reappears (i.e. for the same value of nₑₓₜ) on the entire spectral response.

The technique described in document [1], for taking advantage of the spectral sensitivity of a slanted Bragg grating at nₑₓₜ, is based on a measurement of the spectral response in transmission of such a grating. Once this spectrum has been acquired, an appropriate algorithm determines the surface occupied by the spectral resonances associated with couplings between the guided mode and the cladding modes.

When nₑₓₜ increases, while remaining lower than the refraction index n_{g} of the optical cladding, this surface decreases toward zero. It begins to decrease significantly only after a minimum value set by the effective index of the cladding mode associated with the spectral resonance of lower wavelength discernable on the spectral response in transmission of a slanted Bragg grating placed in the air. When nₑₓₜ has a value equal to n_{g}, the energy diffracted by the slanted Bragg grating is coupled only to the radiation-mode continuum. Consequently, there are no more spectral resonances and the surface thus calculated is zero.

If nₑₓₜ continues to increase, spectral resonances reappear and the surface calculated increases again. These new resonances again correspond to energy coupled to cladding modes that are created due to Fresnel reflections at the optical cladding-external medium interface, and no longer due to a total reflection phenomenon as when nₑₓₜ is lower than n_{g}. The two domains n_{eff,min}<nₑₓₜ<n_{g} and nₑₓₜ>n_{g} correspond to the two possible domains of operation of a refractometer based on a slanted Bragg grating transducer.

We should also note that this refractometry technique requires, for each slanted Bragg grating transducer, an initial calibration phase using refraction index liquids known very specifically for obtaining the calibration curve giving, for a given grating, the change in the surface associated with the cladding resonances as a function of the refraction index nₑₓₜ.

Although it offers numerous advantages over the other optical fibre refractometry techniques, this technique has a number of disadvantages. First, it requires very precise spectral measurements to be performed: its implementation therefore requires the use and integration of a spectrometer in the measurement system. Such an instrument, in addition to increased equipment complexity, involves a high final cost of the measurement system. In addition, the rate of measurement of a refractometer based on this technique is limited primarily by the time of acquisition of the spectral response, and, to a lesser extent, by the time of execution of the algorithm for calculating the surface occupied by the cladding resonances: in practice, this method is limited to measurement rates on the order of 1 Hz.

Finally, and more fundamentally, the measurement technique, based on a detection of peaks in order to calculate the surface occupied by the cladding resonances, does not use all of the information contained in the spectral response. This results in a non-optimal measurement sensitivity and resolution. In addition, also due to the peak detection procedure, the technique is influenced by the crossed sensitivity of the spectral response of the slanted Bragg gratings with regard to influencing parameters such as the temperature and mechanical deformations.

### DESCRIPTION OF THE INVENTION

This invention is intended to overcome the aforementioned disadvantages.

It relates to a system for measuring the refraction index of at least one medium, which system includes:
at least one optical waveguide having first and second ends and comprising at least one slanted Bragg grating, formed in a part of the waveguide, which is placed in contact with the medium, and
a light source optically coupled with the first end of the waveguide in order to send this light there and have it interact with the grating,

this system being characterised in that it also includes:
first means for measuring the optical power of the light diffracted to the radiation-mode continuum, when the light emitted by the source interacts with the grating, and
electronic processing means provided for supplying the value of the refraction index of the medium based on this optical power.

The optical waveguide is, for example, an optical fibre (which can be single-mode or multi-mode) or an integrated optical waveguide (which can also be single-mode or multi-mode).

Preferably, the first measurement means include a first photodetector.

According to a first specific embodiment of the system of the invention, the first measurement means also include an optic provided for collecting the diffracted light and concentrating it on the first photodetector.

This optic can be a lens or an objective or a selfoc-type lens.

The first measurement means can also include a prism with a reflective surface or a mirror by means of which the optic collects the light.

According to a second specific embodiment of the system of the invention, the first measurement means also include a prism with a concave reflective surface or a concave mirror provided for collecting the diffracted light and concentrating it on the first photodetector.

The system of the invention can also include an optical fibre that connects the optic to the first photodetector.

According to a preferred embodiment of the system of the invention, this system also includes second means for measuring the optical power of the light that is transmitted, by the slanted Bragg grating, to the second end of the optical waveguide, and the electronic processing means are provided for determining the ratio of the optical power of the light diffracted to the radiation-mode continuum over the optical power of the light transmitted by the slanted Bragg grating.

The second measurement means preferably include a second photodetector.

These measurement means can also include an optic provided for collecting the light transmitted and concentrating it on the second photodetector.

According to a specific embodiment of the system of the invention, this system also includes:
a light reflector that is placed at the second end of the optical waveguide and provided for reflecting, into this optical waveguide, the light transmitted by the slanted Bragg grating, and
means for optical coupling between, on the one hand, the first end of the optical waveguide and the second measurement means, and, on the other hand, this first end and the light source.

These optical coupling means can include a 2×2-type optical coupler or an optical circulator.

According to a first specific embodiment, the system of the invention includes a plurality of slanted Bragg gratings that have the same spectral response.

According to a specific embodiment of the invention, the system includes:
N slanted Bragg gratings that have the same spectral response, with N being an integer equal to at least 2, and these gratings being counted from the source,
for each grating, second means for measuring the optical power of the light transmitted by this grating, and
for each of the N−1 first gratings, an optical coupler for sampling light, mounted on the optical waveguide, between the associated grating and the next grating, and provided for sending the sampled light to the second corresponding measurement means,

and in which the electronic processing means are provided for determining, for each grating, the ratio of the optical power of the light diffracted by this grating to the radiation-mode continuum over the optical power of the light transmitted by this grating.

According to a second specific embodiment, the system of the invention includes a plurality of slanted Bragg gratings of which the spectral responses are different from one another.

According to a specific embodiment of the invention, the system includes:
N slanted Bragg gratings of which the spectral responses are different from one another, with N being an integer equal to at least 2, and these gratings being counted from the source,
for each grating, second means for measuring the optical power of the light transmitted by this grating, and
for each of the N−1 first gratings, an optical coupler for sampling light, mounted on the optical waveguide, between the associated grating and the next grating, and provided for sending the sampled light to the second corresponding measurement means,

and in which the electronic processing means are provided for determining, for each grating, the ratio of the optical power of the light diffracted by this grating to the radiation-mode continuum over the optical power of the light transmitted by this grating.

According to another specific embodiment of the invention, the system includes:
N slanted Bragg gratings, which are centred on spectral windows different from one another, with N being an integer equal to at least 2, and these gratings being counted from the source,
for each grating, second means for measuring the optical power of the light transmitted by this grating, and
for each of the N−1 first gratings, an optical coupler for sampling light, mounted on the optical waveguide, between the associated grating and the next grating, and provided for sending the sampled light to the second corresponding measurement means,

and in which the electronic processing means are provided for determining, for each grating, the ratio of the optical power of the light diffracted by this grating to the radiation-mode continuum over the optical power of the light transmitted by this grating.

The system of the invention can include a plurality of optical waveguides and optical switching means, provided for successively sending the light supplied by the source into the optical waveguides.

According to a specific embodiment of the invention, the light supplied by the source is amplitude-modulated, at a predefined frequency, and a synchronous detection technique is implemented with the measurement means in order to recover the optical power supplied by these measurement means.

### BRIEF DESCRIPTION OF THE DRAWINGS

This invention can be better understood upon reading the description of example embodiments provided below, purely as a non-limiting indication, with reference to the appended drawings, in which:

FIG. 1 diagrammatically shows an example of the invention, in a transmission configuration,

FIG. 2 diagrammatically shows another example of the invention, in a transmission configuration, with a collection objective,

FIG. 3 diagrammatically shows another example of the invention, in a transmission configuration, with a reflective prism and a collection objective,

FIG. 4 diagrammatically shows another example of the invention, in a configuration for a remote system,

FIG. 5 diagrammatically shows another example of the invention, in a reflection configuration, with an optical coupler,

FIG. 6 diagrammatically shows another example of the invention, in a reflection configuration, with an optical circulator instead of an optical coupler,

FIG. 7 diagrammatically shows a refractometry system according to the invention, with multiplexing by a series arrangement of the gratings and a reference photodetector for each grating,

FIG. 8 diagrammatically shows another refractometry system according to the invention, with spectral multiplexing and a series arrangement of the gratings, and

FIG. 9 diagrammatically shows another refractometry system according to the invention, combining various multiplexing solutions, namely a series arrangement and spectral and time-division multiplexings, with a reference measurement for each grating.

### DETAILED DESCRIPTION OF SPECIFIC EMBODIMENTS

The technique known from document [1] for taking advantage of the spectral sensitivity of a slanted Bragg grating with regard to the refraction index of the external medium, in fact amounts to monitoring the change in the amount of light diffracted by the grating to the cladding modes of the optical fibre in which it is formed, by means of the spectral signature of the grating. The change, as a function of nₑₓₜ, of the coupling of the light energy to the cladding modes of the optical fibre can be done directly only by means of the analysis of spectral resonances associated with them. No other physical signature is directly accessible to the measurement: a spectral measurement is therefore inevitable. However, the spectral contribution of the couplings to cladding modes is not separate from that of the radiation-modes. It is necessary to extract this information from the information present in the spectral response. This explains the complexity of the technique known from document [1].

A much simpler technique could be implemented if the spectral contribution of the cladding modes to the coupling phenomena generated by a slanted Bragg grating could be separated from that of the radiation-mode continuum. However, such a separation could be obtained by analysing the spectrum in reflection. Indeed, a slanted Bragg grating diffracts the light guided by the core of the optical fibre, in which it is formed, to contrapropagative cladding modes, while the light coupled to the radiation-modes escapes the optical fibre (also in a contrapropagative manner). Any variation in the refraction index of the external medium predominantly affects the distribution of the optical power diffracted between the cladding modes and the radiation-mode continuum.

In the previous case, the change in this distribution of diffracted power as a function of nₑₓₜ, at the origin of the sensitivity of a slanted Bragg grating to nₑₓₜ, could be analysed only by means of the spectral response of the grating, measured in transmission (at the end of the fibre). By separating the contribution of the cladding modes from that of the radiation-modes, it is no longer necessary to analyse the spectral response. It is then sufficient to perform a simple measurement of the optical power reflected in the form of cladding modes by the grating. The variations in this reflected power are like those of the refraction index of the external medium, and make it possible, after an initial calibration phase, to use a slanted Bragg grating as a refractometer.

However, such a technique cannot be used because, in reality, the cladding modes are very quickly attenuated during their propagation in the optical fibre (typically after only a few centimetres). A much longer propagation distance (several metres or even several dozen metres) would be necessary to be capable of implementing such a technique under operational conditions. This technique cannot be used in practice.

Therefore, the solution proposed by this invention consists no longer of using the metrological information contained in the cladding modes, but rather that contained in the radiation-mode continuum. Indeed, as mentioned earlier, the energy diffracted to the radiation-modes changed, as a function of nₑₓₜ, in a manner exactly opposite the energy diffracted to the cladding modes. Consequently, the principle of a measurement of the optical power of the light diffracted to the radiation-mode continuum can be retained in order to reach the inductor parameter. Indeed, the energy conveyed by these modes escapes the optical fibre to go to the external medium. Therefore, we do not find, as with the cladding modes, a problem associated with losses during the propagation. It is perfectly possible to measure the optical power conveyed in the form of these radiation-modes, using a simple photodetector carefully positioned outside the optical fibre and possibly associated with other optomechanical components so as to optimise the collection of light energy.

We will return later to the various solutions and technical configurations making it possible to perform such a measurement of power. However, we will now specify that a measurement of the refraction index nₑₓₜ of the external medium, by means of this invention, involves obtaining a calibration curve for a given transducer.

Nevertheless, this invention is based, as for the evanescent wave sensors, on a measurement of power. The technique of the invention is therefore sensitive to any variation in the optical power conveyed by the optical fibre containing the grating, whether it is a variation in the optical power of the interrogating light source or a variation in line losses, or even a drift in the response of the photodetector and the amplification-acquisition chain.

However, in the case of the invention, it is possible to overcome these problems by normalising the measurement with regard to a reference quantity. In the case of the invention, it is proposed to normalise the measurement by taking, as the reference parameter, the optical power transmitted by the slanted Bragg grating. This parameter corresponds to the incident optical power subtracted from the optical power diffracted to the cladding modes and to the radiation-mode continuum (disregarding the losses during the propagation). The validity of this normalisation solution is confirmed below.

The technique of the invention no longer requires the use of a spectral-type measurement: it simply consists of performing the measurement of the optical power diffracted to the radiation-mode continuum and, preferably, the measurement of an optical reference power, namely the power transmitted by the slanted Bragg grating. The change in the ratio between these two measured quantities is unequivocally related to the refraction index of the external medium. A refractometry system based on this measurement technique corresponds to a relatively simple architecture and allows for low cost manufacture of industrialisable products.

In addition, the rates of acquisition are now determined simply by tools for digitisation and application of a processing algorithm (which is much simpler than the algorithm used for the technique known from document [1]) and no longer by the spectral measurement time. It becomes entirely possible to perform measurements at rates ranging from a few Hz to a few dozen kHz.

In addition, the measurement sensitivity and resolution are significantly improved with respect to the technique known from document [1]. Indeed, instead of using only some of the information, namely the amplitude and the localisation of the spectral resonances to the cladding modes, all of the information is used, namely the optical power conveyed in the form of radiation-modes.

Finally, the optical power diffracted to the radiation-modes is not dependent on other parameters such as the temperature or the mechanical deformations: only the spectral signature of the coupling to these radiation-modes is influenced by these parameters. Consequently, the crossed sensitivity of the slanted Bragg gratings with respect to other physicochemical quantities (primarily temperature and deformations) is eliminated. This aspect is particularly important and constitutes an asset with respect to the known refractometry techniques mentioned above.

We will now describe a theoretical formulation of the measurement technique of the invention in order, in particular, to explain and to validate the measurement normalisation technique proposed for eliminating possible optical power variations.

Let Pᵢ and Pₜᵣ be the optical powers, incident on the slanted Bragg grating and transmitted by this same grating, respectively. Let Pᵣ and P_{g} be the optical powers conveyed in the form of radiation-modes and cladding modes, respectively. The light energy not transmitted by the grating corresponds to light diffracted, either to the cladding modes or to the radiation-mode continuum. Consequently, we have the following relation between these four quantities (considering that the losses during propagation, in particular by scattering, are negligible):

Pᵣ+P_{g}=Pᵢ−Pₜᵣ

Let S(λ) be the spectral power density of the optical interrogation source (extending over a spectral window between λ₁ and λ₂) and T(λ) be the spectral transfer function of the slanted Bragg grating, with λ being the wavelength. The incident and transmitted powers are then expressed according to the following relations:

$$\{ \begin{matrix}{P}_{i} = {\int }_{{λ}_{1}}^{{λ}_{2}} S ( λ ) d λ \\ {P}_{tr} = {\int }_{{λ}_{1}}^{{λ}_{2}} S ( λ ) T ( λ ) d λ\end{matrix} \qquad ( 1 )$$

If there are fluctuations in the power of the optical source or line losses independent of the wavelength, the previous relations, giving the incident and transmitted powers, must be modified to take them into account. It is then necessary to introduce a function k(t) representing the power or line loss fluctuations, and taking values between 0 and 1, with t representing the time. Then:

$$\{ \begin{matrix}{P}_{i} k ( t ) {\int }_{{λ}_{1}}^{{λ}_{2}} S ( λ ) d λ \\ {P}_{tr} = k ( t ) {\int }_{{λ}_{1}}^{{λ}_{2}} S ( λ ) t ( λ ) d λ\end{matrix} \qquad ( 2 )$$

Consequently, we reach the following relation:

$$\frac{{P}_{r} + {P}_{G}}{{P}_{tr}} = \frac{{P}_{i}}{{P}_{tr}} - 1 = \frac{{\int }_{{λ}_{1}}^{{λ}_{2}} S ( λ ) d λ}{{\int }_{{λ}_{1}}^{{λ}_{2}} S ( λ ) T ( λ ) d λ} - 1 \qquad ( 3 )$$

The ratio depends only on the wavelength; it does not depend on the intensity fluctuations.

In addition, it is known that the power conveyed by the radiation-modes is unequivocally related to the power conveyed by the cladding modes:

Pᵣ=f(nₑₓₜ)P_{g} (4)

where f is an increasing function on the interval [n_{eff,min};n_{g}], and nₑₓₜ is the refraction index of the external medium.

Consequently, by inserting this relation into relation (3), we obtain:

$$\frac{{P}_{r}}{{P}_{tr}} = \frac{f ( {n}_{ext} )}{1 + f ( {n}_{ext} )} \frac{{\int }_{{λ}_{1}}^{{λ}_{2}} S ( λ ) d λ}{{\int }_{{λ}_{1}}^{{λ}_{2}} S ( λ ) T ( λ ) d λ} - 1 = g ( {n}_{ext} ) \qquad ( 5 )$$

This last relation shows that the measurement of the optical power Pᵣ conveyed in the form of radiation-modes, normalised with respect to the optical power Pₜᵣ transmitted by the slanted Bragg grating, makes it possible to unequivocally reach the value of nₑₓₜ by inverting the function g with respect to the variable nₑₓₜ. In addition, the ratio Pᵣ/Pₜᵣ does not depend on possible power fluctuations over time since the function k(t) has been eliminated.

The refractometry technique described above involves measurements of the optical power diffracted by the slanted Bragg grating in the form of radiation-modes and the power transmitted in the optical fibre by this grating. Various equipment configurations can be envisaged for performing these two measurements. They are differentiated by the optomechanical solutions implemented for collecting the light.

In every case, the solutions for collecting the light diffracted in the form of radiation-modes take advantage of the directive nature of such light beams. Indeed, at a point in the grating, the light diffracted in the form of radiation-modes escapes the fibre in a light cone. This cone has an opening on the order of 1°, and the angle θ_{cone} between the axis of this cone and the axis of propagation of the optical fibre is associated with the angle of tilt θ of the lines of the grating, the pitch Λ of the latter, the refraction index n_{g} of the optical cladding, the propagation constant β₀ of the guided mode and the wavelength λ of the light according to the following relation:

$$cos {θ}_{c \hat{o} ne} = \frac{{β}_{0} - \frac{2 π cos θ}{Λ}}{\frac{2 π {n}_{g}}{λ}}$$

However, the principle of the measurement technique consists of interrogating a slanted Bragg grating with a broadband light source, covering the entire spectral response of this grating. Consequently, it is necessary to recover the light corresponding to all of the interrogation wavelengths. In addition, at a point of the grating, the diffracted light to be collected is distributed in a cone of which the opening is substantially on the order of around ten degrees (a different angle corresponding to each wavelength).

In addition, a slanted Bragg grating is not punctiform: it generally has a length of a few millimetres. Thus, at a given wavelength, the diffracted light corresponds substantially to a line of light that diverges in two directions. According to the axis of the optical fibre, the angle of divergence is substantially on the order of 1°. By contrast, in an azimuthal plane, the divergence is substantially on the order of around ten degrees.

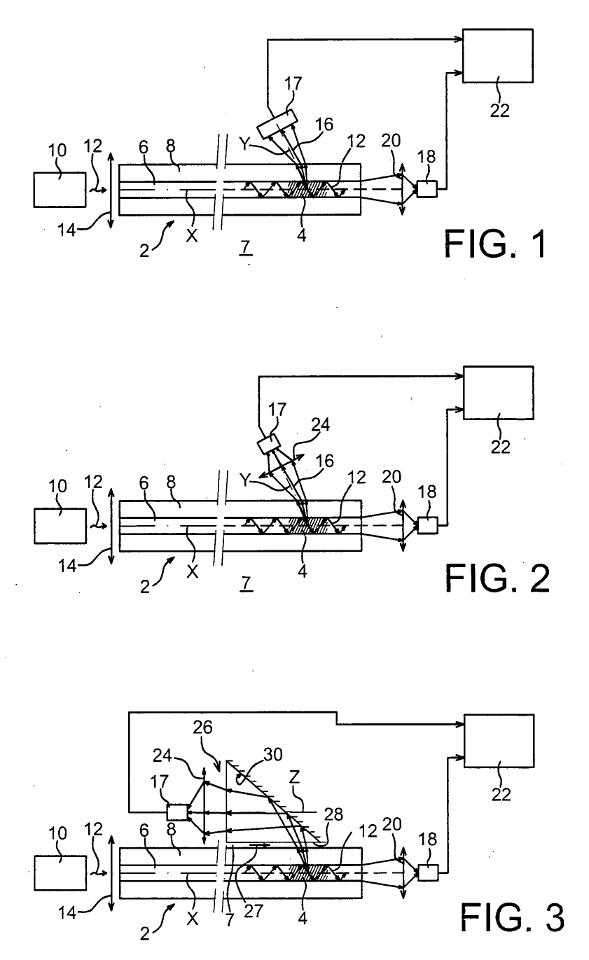

A first solution is diagrammatically shown in FIG. 1. It consists very simply of placing a photodetector at the output of the optical fibre so as to measure Pₜᵣ and another photodetector laterally with respect to the fibre to measure Pᵣ. A mechanical attachment device (not shown) can be used, for example, to adjust and optimise the positioning of the latter photodetector with respect to the diffracted light.

In FIG. 1, the optical fibre (which can be single-mode or multimode) is denoted by reference 2. The slanted Bragg grating 4 is formed in the core 6 of the fibre. This grating is placed in a portion of the fibre that is in contact with the external medium, for example a liquid 7, of which the refraction index is to be measured. The optical cladding of the fibre is denoted by reference 8. The axis of the fibre (axis of the core) is denoted by reference X. A light source 10 is placed opposite an end of the fibre. The light 12 emitted by the source is injected into this end by means of a suitable optic 14 for then being guided by the core of the fibre. The light diffracted to the radiation-mode continuum is denoted by reference 16. The photodetector that detects this light is denoted by reference 17. The other photodetector 18, placed opposite the other end of the fibre, captures the light transmitted by the grating 4. This light is collected and concentrated on the photodetector 18 by means of an appropriate objective 20. Electronic processing means 22 are provided for calculating the ratio Pᵣ/Pₜᵣ on the basis of the signals that they receive from the photodetectors and for providing the value of the refraction index of the medium 7, on the basis of this ratio.

A limitation of the assembly of FIG. 1 arises from the fact that the detection surface of the photodetector 17 is not necessarily suitable for the surface occupied by the light 16 to be collected in the plane of this sensor. According to a second configuration, diagrammatically shown in FIG. 2, an objective 24 is used, which can be limited to a single lens, for collecting the diffracted light 16 and optimally imaging it, i.e. sending almost all of this light, onto the detection surface of the photodetector 17.

For the two assemblies of FIGS. 1 and 2, it is necessary to optimally centre the photodetector 17 and in particular the objective 24 on the central Y-axis associated with the diffracted rays. It can be clearly more advantageous, for manufacturing, to have a reflective prism 26 in front of the collection objective 24 and the photodetector 17 (see FIG. 3). In this way, it is possible to redirect the diffracted light 16 on a Z-axis, which is parallel to the X-axis of the optical fibre 2. The medium 7, of which the refraction index is to be measured, then circulates, according to the arrow 27, in a space of calibrated dimensions, left between the input surface 28 of the prism and the optical fibre 2. The reflective surface 30 of the prism is treated so as to optimally reflect the light at the working wavelengths.

For diffracted light emerging from the optical fibre with smaller output angles than those shown in FIG. 3, it can be beneficial to use a prism of which the reflective surface is located on the left-hand side of FIG. 3. In addition, even if the prism with a reflective surface may be advantageous in terms of practical production, it is nevertheless perfectly possible to consider achieving the same function with a traditional planar mirror.

Finally, whether in the case of the prism with a reflective surface or a traditional mirror, the use of a reflective surface that is no longer planar but concave and focusing, for example, parabolic, enables the assembly to be simplified. Indeed, in this case, it is no longer necessary to use a collection objective after the prism or the mirror: the reflective surface provides the focusing on the photodetector 17.

An additional development can be provided in these architectures so as to allow for remote measurement of the optical power Pᵣ. To perform this remote operation, we again use a reflective prism and a collection objective that, in this case, can advantageously be a selfoc-type lens, connected to a single-mode or multimode optical fibre. The light collected is then injected, by the selfoc lens, into the optical fibre, which then leads the light to a photodetector. In this case, it is entirely possible to move the equipment several hundred metres, or even more, from the measurement zone (depending on the transmission losses of the collection fibre). As regards the power transmitted Pₜᵣ, it is sufficient, for a remote measurement, to appropriately increase the length of fibre available after the Bragg grating.

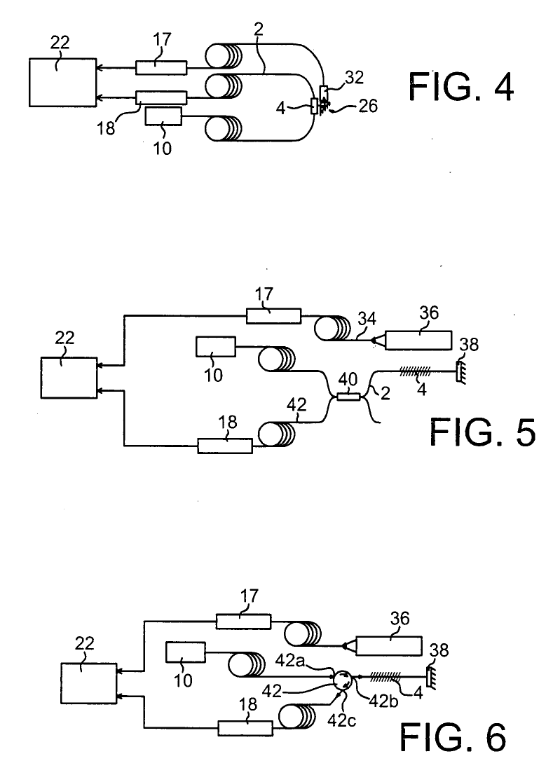

This is diagrammatically shown in FIG. 4, which shows the fibre 2 comprising the slanted Bragg grating 4 and optically coupled, on one side, to the source 10, and, on the other side, to the photodetector 18. It also shows the prism with a reflective surface 26, placed opposite the grating 4, as well as the selfoc lens 32 and the single-mode or multimode optical fibre 34, which connects this lens 32 to the photodetector 17.

In the previous solution, for measuring the transmitted optical power, it is necessary to extend the optical fibre up to the photodetector 18 after the slanted Bragg grating 4. Another option makes it possible to work according to a reflection configuration. In this case, the same optical fibre is used to lead the light to the slanted Bragg grating 4 and to lead the light transmitted by the grating to the detector 18, by means of metallization of the end of the fibre. However, it is then necessary to take into account the fact that there is a double passage in the measurement grating. The consequence of this double pass-age is that the transmitted power, measured by the photodetector, is reduced by a factor of two with respect to a measurement according to a transmission configuration.

Nevertheless, the use of a 2×2-type coupler with a ratio of 50% intrinsically performs this correction. On the other hand, the power associated with the radiation-modes has not to be corrected because the light diffracted in the second passage is directed in a manner diametrally opposed to that diffracted in the first passage. It is therefore not recovered by the collection system.

This is diagrammatically shown in FIG. 5, which shows the optical fibre 2, equipped with the grating 4, opposite the system for collection and coupling 36 (including the prism 26 and the selfoc lens 32 in the example of FIG. 4). After this system 36, is the fibre 34, which is coupled to the photodetector 17.

At one end of the fibre 2, is again the photodetector 18, while the other end is made reflective, for example, by means of a mirror 38 attached to this end. In addition, a 2×2 optical coupler 40 is mounted on this fibre 2, between the grating 4 and the photodetector 18, as seen in FIG. 5, and the two remaining available branches of this coupler 40 are respectively coupled to the light source 10 by means of an optical fibre 42, and left free.

An alternative of this solution consists of replacing the 2×2 coupler 40 with an optical circulator 42 (see FIG. 6). This circulator has three ports 42a, 42b and 42c, as shown in FIG. 6. The light passes from port 42a to port 42b, then from port 42b to port 42c, but cannot go, for example, from port 42b to port 42a. This alternative makes it possible to optimiser the signal-to-noise ratio. However, the double passage in the slanted Bragg grating is not corrected by this circulator, as was the case for the 2×2 coupler.

In general, one of the major benefits of Bragg grating transducer technology lies in the multiplexing capacities of the gratings on a same measurement line. Multiplexed Bragg gratings are identified by their respective resonance wavelengths, and we then refer to spectral multiplexing. The refractometry technique known from document [1] also enables spectral multiplexing to be used.

However, in practice, the number of multiplexable slanted Bragg gratings is very limited. Indeed, the spectral range occupied by a single grating typically ranges from 20 to 30 nm. However, the optical interrogation sources have spectral widths lower than 100 nm. Consequently, on a same line, and with a single source, it is possible to multiplex only 3 to 5 transducers (gratings). These numbers do not constitute a strict limit. The number of multiplexable gratings can be slightly increased, for example, by reducing the spectral width of a grating (to the detriment of the accessible measurement dynamics) or by combining a plurality of suitable broadband optical sources and broadband optical couplers.

By contrast, in the refractometry technique of the invention, which is described above, this limitation inherent to the spectral scope of the gratings and optical sources is entirely eliminated. Indeed, this technique no longer requires a spectral measurement, but only a measurement of power. Consequently, the transducers (gratings) no longer have to be spectrally multiplexed. It is sufficient to assemble them in series on the same measurement line and to associate, with each grating, a cell for measuring the radiation power and the reference power.

If the reference power is the same for all of the gratings, it is possible to measure it at the end of the line, but it is necessary to perform the operation of calibration of each grating once the line has been produced. If the calibration operation is performed grating-by-grating, it is then essential to perform a measurement of the power transmitted after each grating. This is performed very simply by arranging an optical sampling coupler between two adjacent gratings.

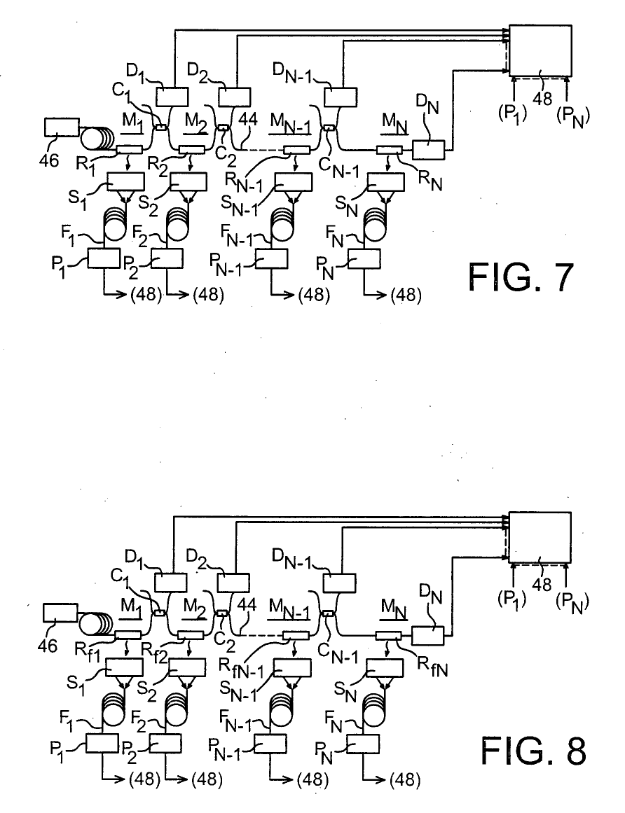

This is diagrammatically shown in FIG. 7, which shows an optical fibre 44 in which N slanted Bragg gratings R₁, R₂ . . . R_{N} are formed, with N being an integer equal to at least 2. These gratings R₁ . . . R_{N} are formed in portions of the fibre 44 that are respectively in contact with external media M₁ . . . M_{N} of which the refraction indices are to be measured.

In fibre 44, in the N−1 intervals separating the gratings R₁ . . . R_{N}, N−1 optical couplers for sampling light C₁, C₂ . . . C_{N-1} are also mounted, which are respectively associated with the gratings. R₁, R₂ . . . R_{N-1}. Systems for collection and coupling S₁, S₂ . . . S_{N} are respectively placed opposite the gratings R₁, R₂ . . . R_{N} and are respectively coupled to N photodetectors P₁, P₂ . . . P_{N} by means of optical fibres F₁, F₂ . . . F_{N}.

There are also N−1 other photodetectors D₁, D₂ . . . D_{N-1}, which are optically connected respectively to the couplers C₁, C₂ . . . C_{N-1} in order to recover the light sampled by the latter. In addition, there is a light source 46 that is optically coupled to an end of the fibre 44 and another photodetector D_{N} that is optically coupled to the other end of the fibre 44 in order to recover the light transmitted by the grating R_{N}. There are also electronic processing means 48 that are electrically connected to the photodetectors P₁ . . . P_{N} and D₁ . . . D_{N} and provided in order to determine the refraction index of the medium Mᵢ on the basis of the ratio of the optical powers respectively obtained by photodetectors Dᵢ and Pᵢ, for every i ranging from 1 to N.

The sampling coefficient can be very low (a few %) so as not to adversely affect the next measurements with regard to the signal-to-noise ratio. By setting the sampling coefficient at a reasonable value, for example 10%, it is then possible to envisage the series arrangement of at least 5 gratings, preferably 5 to 10 gratings, on the same measurement line.

It should be noted that the assembly of FIG. 7 can be used if the gratings have the same spectral response or spectral responses different from one another.

If all of the gratings are on the same spectral band, their series arrangement can create signal-to-noise ratio problems. Indeed, the optical power available on this band must be shared between all of the gratings. To solve this problem, a solution consists of also using the spectral multiplexing in order to use the optical power on all of the available spectral windows, instead of the simple series arrangement of gratings having the same spectral window.

In this case, there is a series arrangement of gratings respectively centred on different spectral windows, preferably adjacent, of which the respective widths match those of the gratings. The number of windows that can be used is determined according to the useful spectral width of the optical interrogation source and that of the slanted Bragg gratings. The order of gratings mounted in series has no importance. Given the classic spectral widths of slanted Bragg gratings, namely 20 to 30 nm, and the spectral scope of optical interrogation sources commercially available (up to 100 nm), there are 3 to 5 distinct spectral windows.

This is diagrammatically shown in FIG. 8. The assembly seen in this FIG. 8 is identical to the assembly seen in FIG. 7, except that the gratings R₁ . . . R_{N} of FIG. 7 are respectively replaced by gratings R_{f1}, R_{f2} . . . R_{fN} that are centred on adjacent spectral windows f1, f2 . . . fN.

Finally, it is also entirely possible to implement other multiplexing solutions, for example, time-division multiplexing, using an optical switch to sequentially analyse a plurality of measuring channels. If this optical switch is implemented, the reference power can be measured by transmission after each sensor (grating), or measured by transmission with a photodiode placed at the end of the measurement line, or measured by reflection with a single photodiode for all of the measurement lines that are connected to the switch.

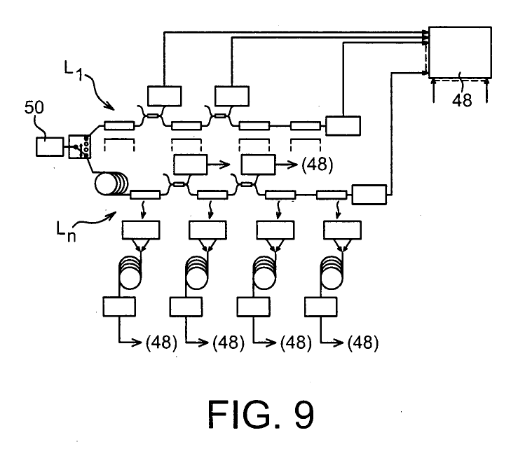

FIG. 9 diagrammatically shows the case in which the reference power is measured by transmission after each grating. There are the different measurement lines L₁ . . . Lₙ (n integer equal to at least 2), which are connected to an interrogation light source 50 by means of an optical switch 52. each line is of the type shown in FIG. 8. There are also electronic processing means 54, which are connected to all of the photodetectors of the system of FIG. 9.

Without an optical switch, the number of multiplexable gratings per channel can be on the order of 15 to 50. In the case of the use of time-division multiplexing (optical switch), this number is then multiplied by the number of channels of the switch. Typically, it is possible to find 1×8 or even 1×16 switches on the market. It is thus possible to envisage the interrogation of more than 90 sensors (=8×15).

One of the solutions presented above can be improved by using a measurement technique based on synchronous detection. This approach consists of an amplitude modulation of the signal of the optical interrogation source at a frequency f. By using synchronous detection, it is then possible to extract, from the noise, the relevant information on each of the two photodetectors of the measurement system. Thus, sources of parasitic light (ambient light, for example) are eliminated. Such a solution makes it possible mainly to obtain a signal-to-noise ratio and therefore a measurement resolution that are much better.

The examples of the invention provided above relate to slanted Bragg gratings formed in optical fibres. However, a person skilled in the art can easily adapt these examples to the case in which the gratings are formed in other optical waveguides, for example integrated optical waveguides (single-mode or multimode).

This invention provides numerous improvements with respect to the technique known from document [1]. First, the refractometry technique of the invention no longer requires a measurement of the spectral response of the slanted Bragg grating. Only one, or preferably only two optical power measurement(s), is (are) required, namely a first measurement of the optical power diffracted to the radiation-modes, and, preferably a second measurement of the optical power transmitted by the grating, as a normalisation quantity. The measurement concept is therefore radically different. The conception considered in the invention first makes it possible to very significantly reduce the cost and the complexity of the system (no spectrum analyser).

In addition, from the software perspective, the measurement technique of the invention requires only insignificant processing since it is limited to the ratio between two optical powers. In the technique known from document [1], the acquisition and processing time of the spectrum of the transducer (grating) limited the measurement bandwidth to 1 Hz. With the invention, the bandwidth is limited only by the digitisation hardware tools. Consequently, measurement rates of several dozen kHz can be envisaged. As regards the metrological performances, the measurement dynamics are also very substantial: it is possible to perform refraction index measurements on ranges from 1.3 to 1.7.

Furthermore, the technique of the invention makes it possible to use all of the relevant physical information, while the measurement technique used previously truncated this information: instead of using the entire spectral response, only the valleys and the peaks of the spectral resonances were used. In addition, the basic measurement chain is limited to an optical source, two photodiodes and a digital acquisition board. In the system known from document [1], this chain also comprised a spectrum analyser. By eliminating a potential measurement noise source and by taking advantage of all of the useful physical information, the measurement resolution and sensitivity are both increased. These two quantities are limited only by the electronic noise at the photodetectors and the amplification circuits of the latter, as well as by the resolution of the corresponding acquisition board.

Finally, the invention makes it possible to envisage numerous multiplexing solutions: measurement systems that are remote and interfaced with several dozen multiplexed gratings can easily be envisaged.

1. System for measuring the refraction index of at least one medium, which system includes:
at least one optical waveguide (2, 44) having first and second ends and comprising at least one slanted Bragg grating (4, R₁ . . . R_{N}, R_{F1} . . . R_{FN}), formed in a part of the waveguide, which is placed in contact with the medium, and
a light source (10, 46, 50) optically coupled with the first end of the waveguide in order to send this light there and have it interact with the grating,
this system being characterised in that it also includes:
first means (17, P₁ . . . P_{N}) for measuring the optical power of the light diffracted to the radiation-mode continuum, when the light transmitted by the source interacts with the grating, and
electronic processing means (22, 48, 54) provided for supplying the value of the refraction index of the medium based on this optical power.

2. System according to claim 1, wherein the optical waveguide is an optical fibre (2, 44).

3. System according to claim 1, wherein the optical waveguide is an integrated waveguide.

4. System according to claim 1, wherein the first measurement means include a first photodetector (17, P₁ . . . P_{N}).

5. System according to claim 4, wherein the first measurement means also include an optic (24, 32) provided for collecting the diffracted light and concentrating it on the first photodetector.

6. System according to claim 5, wherein the optic is a lens or an objective (24) or a selfoc-type lens (32).

7. System according to claim 5, wherein the first measurement means also include a prism (26) with a reflective surface or a mirror, by means of which the optic collects the light.

8. System according to claim 4, wherein the first measurement means also include an optic prism with a concave reflective surface or a concave mirror for collecting the diffracted light and concentrating it on the first photodetector.

9. System according to claim 5, wherein it also includes an optical fibre (34) that connects the optic to the first detector.

10. System according to claim 1, wherein it also includes second means (18, D₁ . . . D_{N}) for measuring the optical power of the light that is transmitted, by the slanted Bragg grating, up to the second end of the optical waveguide, and in which the electronic processing means are provided for determining the ratio of the optical power of the light diffracted to the radiation-mode continuum over the optical power of the light transmitted by the slanted Bragg grating.

11. System according to claim 10, wherein the second measurement means include a second photodetector (18, D₁ . . . D_{N}).

12. System according to claim 11, wherein the second measurement means also include an optic (20) for collecting the transmitted light and concentrating it on the second photodetector.

13. System according to claim 10, also including:
a light reflector (38) that is placed at the second end of the optical waveguide and provided for reflecting, into this optical waveguide, the light transmitted by the slanted Bragg grating, and
means (40, 42) for optical coupling between, on the one hand, the first end of the optical waveguide and the second measurement means, and, on the other hand, this first end and the light source (10).

14. System according to claim 13, wherein the optical coupling means include a 2×2-type optical coupler (40) or an optical circulator (42).

15. System according to claim 1, including a plurality of slanted Bragg gratings (R₁ . . . R_{N}) that have the same spectral response.

16. System according to claim 1, including:
N slanted Bragg gratings (R₁ . . . R_{N}) that have the same spectral response, with N being an integer equal to at least 2, and these gratings being counted from the source,
for each grating, second means (D₁ . . . D_{N}) for measuring the optical power of the light transmitted by this grating, and
for each of the N−1 first gratings, an optical coupler (C₁ . . . C_{N-1}) for sampling light, mounted on the optical waveguide, between the associated grating and the next grating, and provided for sending the sampled light to the second corresponding measurement means,
and in which the electronic processing means (48) are provided for determining, for each grating, the ratio of the optical power of the light diffracted by this grating to the radiation-mode continuum over the optical power of the light transmitted by this grating.

17. System according to claim 1, including a plurality of slanted Bragg gratings of which the spectral responses are different from one another.

18. System according to claim 1, including:
N slanted Bragg gratings (R₁ . . . R_{N}) of which the spectral responses are different from one another, with N being an integer equal to at least 2, and these gratings being counted from the source,
for each grating, second means (D₁ . . . D_{N}) for measuring the optical power of the light transmitted by this grating, and
for each of the N−1 first gratings, an optical coupler (C₁ . . . C_{N-1}) for sampling light, mounted on the optical waveguide, between the associated grating and the next grating, and provided for sending the sampled light to the second corresponding measurement means,
and in which the electronic processing means (48) are provided for determining, for each grating, the ratio of the optical power of the light diffracted by this grating to the radiation-mode continuum over the optical power of the light transmitted by this grating.

19. System according to claim 1, including:
N slanted Bragg gratings (R_{F1} . . . R_{FN}), which are centred on spectral windows different from one another, with N being an integer equal to at least 2, and these gratings being counted from the source,
for each grating, second means (D₁ . . . D_{N}) for measuring the optical power of the light transmitted by this grating, and
for each of the N−1 first gratings, an optical coupler (C₁ . . . C_{N-1}) for sampling light, mounted on the optical waveguide, between the associated grating and the next grating, and provided for sending the sampled light to the second corresponding measurement means,
and in which the electronic processing means (48) are provided for determining, for each grating, the ratio of the optical power of the light diffracted by this grating to the radiation-mode continuum over the optical power of the light transmitted by this grating.

20. System according to claim 1, including a plurality of optical waveguides and optical switching means (52), provided for successively sending the light supplied by the source into the optical waveguides.

21. System according to claim 1, wherein the light supplied by the source is amplitude-modulated, at a predefined frequency, and a synchronous detection technique is implemented with the measurement means in order to recover the optical power supplied by these measurement means.
